(19) United States
(12) Patent Application Publication
(10) Pub. No.: US 2009/0078139 A1
(43) Pub. Date: Mar. 26, 2009

(54) MAGNETIC PLATE RETENTION

(75) Inventors: James V. Lovenstein, Nashua, NH (US); James R. Moss, Lake Mary, FL (US)

Correspondence Address: GOODWIN PROCTER LLP;PATENT ADMINISTRATOR, 53 STATE STREET, EXCHANGE PLACE, BOSTON, MA, 02109-2881, US

(73) Assignee: Presstek, Inc., Hudson, NH (US)

(21) Appl. No.: 12/325,695

(22) Filed: Dec. 1, 2008

Related U.S. Application Data
(63) Continuation of application No. 10/729,045, filed on Dec. 5, 2003, now abandoned.

(51) Int. Cl. B41F 27/00

(52) U.S. Cl. 101/389.1

(57) ABSTRACT

A magnetic plate retention system especially suitable for use in retaining a lithographic plate material to a conventional plate cylinder utilizes one or more magnetic retention devices each having a curved surface complementary to the cylinder. When disposed on the plate, the retention devices magnetically adhere the plate to the underlying cylinder.

### BACKGROUND OF THE INVENTION

1. Field of the Invention

This invention relates generally to clamping systems and methods and more particularly to clamping systems and methods for releasably securing a printing plate to a plate cylinder.

2. Description of the Related Art

In offset lithography, an image is present on a printing plate as a pattern or “image” of ink-accepting (oleophilic) and ink-repellent (oleophobic) surface areas. In a typical sheet-fed offset press system, the imaged plate is mounted to a plate cylinder, where it is inked. The plate is then brought into contact with the compliant surface of a blanket cylinder. The blanket cylinder, in turn, applies the image to paper sheets which are brought into contact with the blanket cylinder by an impression cylinder.

Although the plates for an offset press were traditionally imaged photographically, more recently, a number of electronic alternatives have been developed for placing the image onto the plate. These digitally controlled imaging devices include lasers that chemically alter or destroy one or more plate layers, ink jets that directly deposit ink-repellent or ink-accepting spots on a plate blank and spark or ion discharge devices which physically alter the topology of the plate blank. These various methods of imaging lithographic plates are described in detail in U.S. Pat. Nos. 3,506,779, 4,054,094, 4,347,785, 4,911,075 and, 5,385,092 among others.

Plates can be imaged on-press or, more traditionally, on an off-press platesetter. A digitally operated platesetter includes an imaging cylinder to which the plate is initially mounted, and which carries the plate past the head of the imaging device. That device transfers the image to the plate. The imaged plate is then removed from the platesetter and transferred to the plate cylinder of the printing press.

When mounting an imaged plate to a plate cylinder for a press run or when mounting a plate blank to an imaging cylinder for imaging, it is essential that the leading and trailing edges of the plate be secured firmly to the cylinder and that the plate be wrapped tightly around the cylinder. This ensures that there will be no relative movement between the plate and the cylinder when the cylinder is rotated. Likewise, when a donor/acceptor sheet set is mounted to a cylinder for platemaking by thermal transfer, both sheets must be firmly clamped to the plate to avoid relative movement. The clamp must also have a thickness (i.e., a radial extension from the cylinder) less than the focal length of the imaging device in order to avoid contact with the device as the cylinder rotates.

Various devices, including vacuum clamps and mechanical and electromechanical clamps, have been developed over the years for holding a lithographic plate to a plate cylinder. For the most part, theses devices have all tended to be relatively complex and costly. Such devices typically require relatively large and heavy metal plates as components of the clamping mechanism which, when attached to the plate cylinder, create a substantial “void” segment on the cylinder. Also, in most cases, the clamping mechanisms are fixed to the cylinders such that the mechanisms can only secure a printing plate having a specific length. Since the plate blanks are often pre-cut to fit the specific plate cylinder of the printing press, a separate imaging cylinder, having the same dimensions as the printing cylinder, is generally used to image the plates associated with each printing press. The inability of platesetter and printing cylinders to accommodate differently sized plates substantially increases the cost of operating the printing press.

### DESCRIPTION OF THE INVENTION

### Brief Summary of the Invention

The present invention enables rapid, efficient mounting of a recording member, such as a lithographic plate to a plate cylinder for printing. It is equally applicable for securing a plate blank or a donor/acceptor sheet for plate-making.

Briefly, the invention utilizes one or more magnetic retention devices each having a curved surface complementary to the cylinder. When disposed on the plate, the retention devices magnetically adhere the plate to the underlying cylinder.

Accordingly, in a first aspect, a retention device for securing a recording medium to a rotatable cylinder has at least a magnetically susceptible surface. The retention device is configured for releasable attachment to the cylinder over the recording medium and comprises a curved surface complementary to the cylinder curvature. Associated with the surface is at least one magnetic element. In some embodiments, the surface has a series of small magnetic elements distributed thereover (and which may be recessed with respect thereto). In other embodiments, the surface is itself a unitary magnetic element. The envelope defined by the rotating cylinder with clamps attached remains outside the closest approach of any imaging device used to image the recording medium, so no contact is possible. For example, the retention device may have a thickness less than the focal length of the imaging device.

In a second aspect, a method for securing a recording medium to a cylinder having at least a magnetically susceptible surface involves providing a retention device comprising a curved surface complementary to the cylinder curvature and, associated with the surface of the retention device, at least one magnetic element. The retention device is positioned proximate to the cylinder, and attraction of the magnetic element(s) for the cylinder causes the retention device to be magnetically attached to the cylinder, thereby securing the recording medium thereto.

The foregoing and other objects, features and advantages of the present invention disclosed herein, as well as the invention itself, will be more fully understood from the following description of preferred embodiments and claims, when read together with the accompanying drawings. In the drawings, like reference characters generally refer to the same parts throughout the different views. The drawings are not necessarily to scale, emphasis instead generally being placed upon illustrating the principles of the invention.

### BRIEF DESCRIPTION OF THE DRAWINGS

The foregoing discussion will be understood more readily from the following detailed description of the invention, when taken in conjunction with the accompanying drawings, in which:

FIG. 1 is a perspective view of a plate-retention device in accordance with the invention;

FIG. 2 is an enlarged perspective view of a portion of one embodiment of the device shown in FIG. 1;

FIG. 3 schematically illustrates devices in accordance with the invention in use; and

FIG. 4 is an enlarged perspective view of a portion of the device shown in FIG. 1 illustrating removable attachment thereto of a handle.

### DETAILED DESCRIPTION OF THE PREFERRED EMBODIMENTS

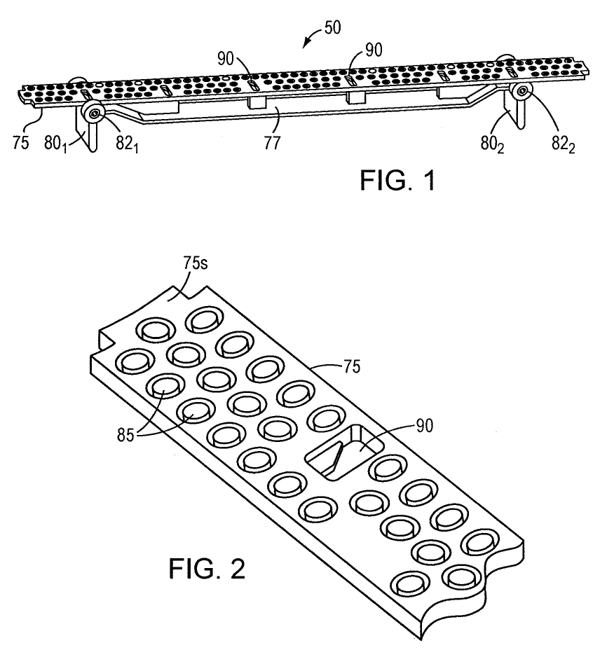

With reference to FIGS. 1, 2, and 3, an embodiment of the invention comprises one or more elongated retention devices 50 for retaining, in one embodiment, a printing plate 55 wrapped around the outer surface of a plate cylinder 60. The plate cylinder 60 rotates about longitudinal axis A-A in the direction of the arrow by a cylinder motor 65 under the control of a programmable controller 67 having a user input device 67a for entering instructions therein. The controller 67 may receive signals from a shaft encoder 69 coupled to plate cylinder 60 opposite the cylinder motor 65 which enables the controller 67 to monitor and set at selected positions the angular position of plate cylinder 60 about its axis of rotation A-A. Cylinder 60 may be part of a printing, imaging or proofing apparatus and is configured to support a flexible sheet such as the printing plate 55.

In one embodiment, a retention device 50_{L} is attached proximate to the leading edge of a printing plate 55 along the axial length of plate cylinder 60, and a retention device 50_{T} is attached proximate to the trailing edge of the printing plate 55 along the axial length of plate cylinder 60 as shown. As discussed below, the clamping system can accommodate printing plates 55 of different dimensions. An imaging array 70 is located adjacent to the plate cylinder 60 for imaging printing plate 55 in accordance with, for example, the '075 and/or '092 patents.

The imaging array 70 may comprise a series of lasers whose outputs are provided directly to the plate surface via lenses or other beam-guiding components, or transmitted to the surface of plate 60 from a remotely sited laser using a fiber-optic cable. A controller and associated positioning hardware maintains the beam outputs at a precise orientation with respect to the plate surface, scans the output over the surface, and activates the laser at positions adjacent selected points or areas of the plate. The controller responds to incoming image signals corresponding to the original document or picture being copied onto the plate to produce a precise negative or positive image of that original. The image signals are stored as a bitmap data file on a computer. Such files may be generated by a raster image processor (RIP) or other suitable means. For example, a RIP can accept input data in page-description language, which defines all of the features required to be transferred onto the printing plate, or as a combination of page-description language and one or more image data files. The bitmaps are constructed to define the hue of the color as well as screen frequencies and angles.

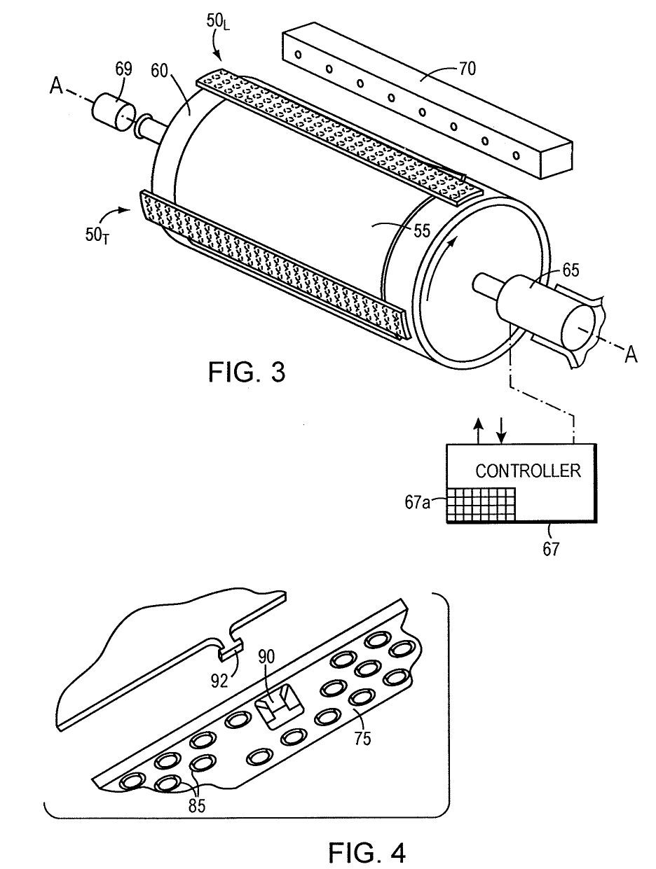

The configuration illustrated in FIG. 3 typically operates on its own, functioning as a platesetter. Following imaging, retention devices 50 are removed, and the plate 55 withdrawn from the cylinder 60. Alternatively, the illustrated components can be incorporated directly into a lithographic printing press. In the latter case, printing may commence immediately after application of the image to a blank plate, thereby reducing press set-up time considerably.

With reference to FIG. 1, the retention device 50 is based on an elongated bar 75. To facilitate application of the bar to cylinder 60, a supporting frame 77 is removably affixed thereto. Supporting frame 77 includes a pair of handles 80₁, 80₂ that rotate on pivots 82₁, 82₂, respectively, with respect to frame 77 (and bar 75). As shown in FIG. 2, bar 75 is generally contoured along an arc substantially matching the curvature of cylinder 60. Preferably recessed within the thickness of bar 75 are a series of discrete magnetic elements 85 arranged in an array extending along much of the length of bar 75. The magnetic elements 85 may be of any shape and be arranged in any configuration along bar 75 that permits adequate magnetic adhesion of retention device 50 to plate cylinder 60 during cylinder rotation. In particular, the longitudinal extent of the array of magnets 85 is preferably at least as great as the width of the widest plate 55 that the device 50 will clamp. It should be emphasized that an array of discrete magnetic elements, while convenient, is not strictly necessary. Instead, the entire bar 75 (or portions thereof) may be magnetic. Bar 75 and frame 77 may be constructed from cold-rolled steel, heavy-duty plastic or other suitable material.

Gripping handles 80₁, 80₂, a user brings the retention device 50 into contact with the edge of plate 55. Attraction of the magnetic elements 85 for the cylinder causes the retention device to be magnetically attached to the cylinder, thereby securing the sandwiched plate 55 to the cylinder surface. The user may then rotate the handles 80₁, 80₂ on pivots 82₁, 82₂ into parallel opposition to bar 75. In this folded configuration, handles 80₁, 80₂ do not interfere with rotation of cylinder 60. Preferably, the handles mechanically lock into this position.

More desirably, however, frame 77 is fully removable, so that once the retention device 50 is positioned against the plate and cylinder, the frame may be detached (and re-attached following the print job to facilitate removal of the retention device and the plate). With reference to FIGS. 2 and 4, frame 77 may be removably secured to bar 75 via a series of slots 90, each of which has a Y-shaped opening. Portions of frame 77 aligned with slots 90 include a T-pin 92 (FIG. 4), which is introduced through the flared portion of a slot 90. Once they have cleared the slots 90, pins 90 are drawn into the necks of the slots, and frame 77 can now be handled to manually position bar 75 with respect to cylinder 60. Frame 77 is removed by withdrawing the T-pins 92 through the flared portions of the slots 90.

This approach can also be in an automated system that retains a bar 77 on a series of T-pins 92. When an appropriate point in the rotation of cylinder 60 is reached, the automated system advances bar 77 radially toward the cylinder until bar 77 magnetically adheres to the cylinder. A small rotation of the cylinder aligns the T-pins 92 with the flared portions of slots 90, allowing the system to be withdrawn. When it is time to remove bar 77 from cylinder 60, the process is reversed; pins 92 enter into slots 90, and a small rotation of cylinder 60 locks them in place behind the slot necks, allowing the system to detach the bar 77 by retreating away from cylinder 60.

Retention devices 50 may releasably secure plate 55 anywhere along the circumferential surface of cylinder 60, but are preferentially placed proximate to a leading edge and a trailing edge of printing plate 55 as shown in FIG. 3. Because placement of the retention devices 50 may occur anywhere along the circumferential surface of cylinder 60, printing plates 55 of different lengths may be easily accommodated by the retention system according to the invention.

It will therefore be seen that we have developed a system for retaining and releasing a recording member such as a lithographic printing plate or donor/acceptor sheets to a cylinder for printing. The system as described herein does not require a modified plate cylinder and easily permits retention of recording members of varying dimension. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A retention device for securing a recording medium to a rotatable, magnetically susceptible cylinder, the retention device being configured for releasable attachment to the cylinder over the recording medium and comprising a curved surface complementary to a curvature of the cylinder and, associated with the surface, at least one magnetic element.

2. The apparatus of claim 1 wherein the retention device comprises a plurality of magnetic elements distributed over the surface.

3. The apparatus of claim 1 wherein the magnetic elements are recessed within the device so as not to protrude beyond the surface.

4. The apparatus of claim 1 wherein the entire surface is magnetic.

5. The apparatus of claim 1 further comprising a removable handle to facilitate application and removal of the retention device.

6. A method for securing a recording medium to a magnetically susceptible cylinder, the method comprising the steps of:
a. providing a retention device comprising a curved surface complementary to a curvature of the cylinder and, associated with the surface, at least one magnetic element; and
b. positioning the retention device proximate to the cylinder, attraction of the at least one magnetic element for the cylinder causing the retention device to be magnetically attached to the cylinder so as to secure the recording medium thereto.

7. The method of claim 6 wherein the retention device comprises a plurality of magnetic elements distributed over the surface.

8. The method of claim 6 wherein the magnetic elements are recessed within the device so as not to protrude beyond the surface.

9. The method of claim 6 wherein the entire surface is magnetic.

10. The method of claim 6 wherein the positioning step is accomplished using at least one handle portion removably associated with the retention device.
